(19) United States
(12) Patent Application Publication
(10) Pub. No.: US 2011/0133105 A1
(43) Pub. Date: Jun. 9, 2011

(54) Automatic faucet with control of water temperature and water flow

(76) Inventor: Joel Stuart Simon, New York, NY (US)

(21) Appl. No.: 12/656,948

(22) Filed: Feb. 22, 2010

(51) Int. Cl. F16K 31/02

(52) U.S. Cl. 251/129.04

(57) ABSTRACT

This disclosure presents an improved automatic faucet/sink. Conventional automatic faucets, such as are present in public locations outside of the home, such as restaurants and roadside rest-stops, allow the on/off control of water flow. Existing automatic faucets do not allow for control over temperature of the water flow. This invention will provide hygienic access to the water faucet for washing the hands since the user does not have to touch the faucet or sink for control over water flow or temperature. Control of water temperature will represent an improvement in automatic faucets.

The invention disclosed here provides for the control of water temperature in automatic faucets. In one implementation this is accomplished with a distance sensor in the faucet that varies the water temperature depending on the distance of the hands under the water spout from the distance sensor. In a second implementation, a microphone with voice-recognition capabilities responds to words (e.g. hotter or colder) to vary the temperature of the water.

### BACKGROUND OF THE INVENTION

Automatic faucets that control their water flow without the user physically touching part of the sink have hygienic advantages as well as greater ease of use. There is one major problem with automatic sinks that has both limited their adoption in public facilities as well as keeping them from reaching the home market: The user is unable to vary the temperature of the water.

This invention offers a solution through an automatic faucet in which the user can vary the temperature of the water without physically touching any part of the sink. This would maintain the hygienic and ease of use of the automatic sinks and add a critical new capability that would make them both more appropriate for public facilities as well as for home or private use.

### BRIEF DESCRIPTION OF THE DRAWINGS

FIG. 1 is a two-dimensional, side view of the invention showing an automatic faucet having a distance sensor and having a master water on/off and temperature control valve.

FIG. 2 is a two-dimensional, side view of the invention showing an automatic faucet having a proximity sensor, microphone and having a master water on/off and temperature control valve.

### BRIEF SUMMARY OF THE INVENTION

An automatic faucet is disclosed in which a user can alter the water flow as well as the temperature of the water flow without physically contacting the sink.

In one such embodiment of the invention, a distance sensor is incorporated into the faucet. When the hands of a user are placed under the faucet, the water flow is turned on and the temperature is adjusted according to the distance of the hands of the user to the distance sensor. The distance sensor is used to control the relative flow rates of the cold and hot water inlets.

In a second such embodiment, a microphone is incorporated into part of the sink. When the hands of a user are placed under the faucet, the water flow is turned on. The temperature is adjusted according to the microphones detecting the words “warmer” or “colder”. A voice recognition chip controls the relative flow rates of the cold and hot water inlets.

### DETAILED DESCRIPTION OF THE INVENTION

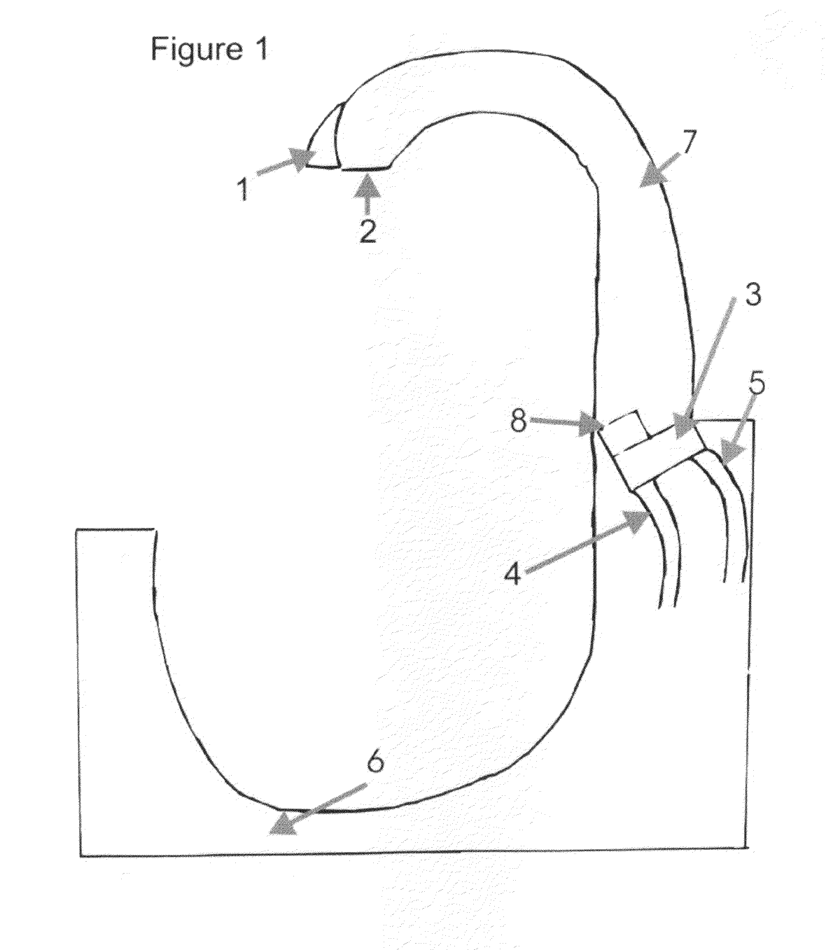

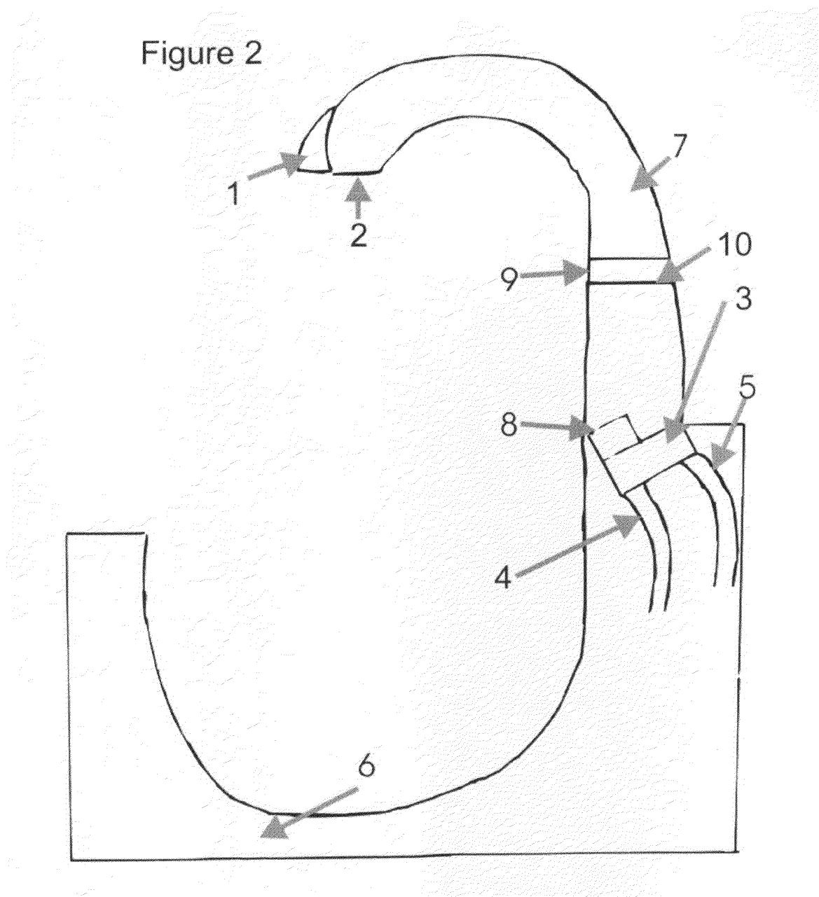

1) Automatic sink/faucet with a proximity/distance sensor for controlling water flow and temperature.
The automatic faucet/sink of this invention is shown in a two-dimensional side view (FIG. 1).
Structure: A faucet 7 is shown mounted in a sink 6. The faucet 7 has a distance sensor 1 adjacent to a water outlet spout 2. The distance sensor 1 is oriented downwards toward the base of the sink 6. A water control value 3 has hot 4 and cold 5 water. Electronics 8 link the distance sensor 1 to the master control valve 3. The master water control valve 3 receives informational input from the distance sensor 1 through the electronics 8 to regulate the flow of hot 4 and cold 5 water.
Function: In the absence of an obstruction between the distance sensor 1 and the base of the sink 6, the master control valve 3 is maintained in the off position and no water flows. When a user places their hands under the water spout 2, the distance sensor 1 detects an obstruction (the hands) as well as the distance of the obstruction from the distance sensor 1. The master control valve 3 then turns on the water and also sets the hot 4 and cold 5 water inlets to a temperature that depends on the distance of the obstruction from the distance sensor 1.
2) Automatic sink/faucet with a proximity sensor for controlling water flow and voice-activation for controlling temperature.
The automatic faucet/sink of this invention is shown in a two-dimensional side view (FIG. 2).
Structure: A faucet 7 is shown mounted in a sink 6. The faucet 7 has a proximity sensor 1 adjacent to a water outlet spout 2. The proximity sensor 1 is oriented downwards toward the base of the sink 6. A water control value 3 has hot 4 and cold 5 water. Electronics 8 link the proximity sensor 1 to the master control valve 3. A microphone 9 is mounted on the sink and connected to a voice recognition chip 10. The master water control valve 3 receives on/off information from the proximity sensor 1 and receives input from the voice recognition chip 10 through the electronics 8 to regulate the flow of hot 4 and cold 5 water.
Function: In the absence of an obstruction between the distance sensor 1 and the base of the sink 6, the master control valve 3 is maintained in the off position and no water flows. When a user places their hands under the water spout 2, the distance sensor 1 detects an obstruction (the hands) as well as the distance of the obstruction from the distance sensor 1. The master control valve 3 then turns on the water. In response to recognition of specific words (e.g. hot, hotter, cold, colder), the voice recognition chip 10 adjusts the hot 4 and cold 5 water inlets.

I claim:

1) An automatic faucet having:
a) Water Spout
b) A Touch-less sensor for controlling the water temperature
i) i) embodiment #1: A distance sensor detects the distance between the hands of the user and the water spout. An electronic signal from the distance sensor
ii) ii) embodiment #2: A microphone with a voice recognition chip.
c) A Master Water Control Valve able to control water flow and water temperature.
d) Hot and Cold Water inlets to the master control valve
e) Electronics linking the touch-less sensor to the master water control valve:
iii) Embodiment #1: whereby when a user places their hands under the distance sensor, water flows at a temperature depending on the distance of the hands from the distance sensor.
iv) Embodiment #2: Whereby when the users uses specific words t (e.g. “hotter” or “colder”) that are recognized by the voice recognition chip, the water temperature is adjusted appropriately.
